(19) United States
(12) Patent Application Publication
(10) Pub. No.: US 2017/0142366 A1
(43) Pub. Date: May 18, 2017

(54) Video Playing Method and Device

(71) Applicants: Le Holdings (Beijing) Co., Ltd., Beijing (CN); Le Shi Internet Information Technology Corp. Beijing, Beijing (CN)

(72) Inventor: Yu Zhao, Beijing (CN)

(21) Appl. No.: 15/247,374

(22) Filed: Aug. 25, 2016

Related U.S. Application Data
(63) Continuation of application No. PCT/CN2016/084700, filed on Jun. 3, 2016.

(30) Foreign Application Priority Data
Nov. 18, 2015 (CN) 201510797405.7

(51) Int. Cl. H04N 5/93; H04N 21/454; H04N 21/45; H04N 5/91; G11B 27/022

(52) U.S. Cl. CPC H04N 5/9305; H04N 5/91; G11B 27/022; H04N 21/4532; H04N 21/4542; H04N 2005/91357

(57) ABSTRACT

The embodiments of the present disclosure provide a video playing method and a video playing device applied to an electronic device, wherein the method includes: acquiring video data to play, and displaying the image contents of the video data in a display interface of the electronic device; detecting the image contents in the video data; and displaying an alternative image in the display interface of the electronic device to cover illegal contents when illegal contents satisfying a first illegal condition are detected in the image contents currently displayed. The embodiments of the present disclosure improve the protection effectiveness and convenience of videos.

### CROSS-REFERENCE

This application is a continuation of PCT/CN2016/084700 filed Jun. 3, 2016 which is based upon Chinese Patent Application 201510797405.7, titled “Video Playing Method and Device”, filed Nov. 18, 2015, the entire contents of which are incorporated herein by reference.

### TECHNICAL FIELD

The embodiments of the present disclosure relate to the field of video technologies and more particularly, to a video playing method and a video playing device.

### BACKGROUND

With the development of electronic technologies and network technologies, video types and viewing manners are more abundant, wherein there are unavoidable contents that are inappropriate for children to view in the videos, for example, those illegal contents such as pornographic contents, violent contents, or the like.

Because the identification ability of the children is limited, it becomes a major concern for the future society to avoid spreading illegal video contents to the children and ensure the physical and psychological health development of the children.

While in the conventional ways, the only manner for avoiding the children from viewing the illegal contents is to prevent the children from viewing when the illegal contents in the videos are played, or to select other videos suitable for the children to view. The protection manner is more tedious and needs to be performed artificially. Moreover, the protection effectiveness is lower because the videos may possibly include other contents suitable for the children to view excluding the illegal contents.

### SUMMARY

The embodiments of the present disclosure provide a video playing method and a video playing device, for solving the technical problem of low protection effectiveness of videos in the prior art.

The embodiments of the present disclosure provide a video playing method, including the following steps:

at an electronic device with a display interface:

video data is acquired to play, and the image contents of the video data are displayed in the display interface of the electronic device;

the image contents in the video data are detected;

an alternative image in the display interface of the electronic device is displayed to cover illegal contents when illegal contents satisfying a first illegal condition are detected in the image contents currently displayed.

The embodiments of the present disclosure provide a video playing device, including:

a video playing module configured to acquire video data to play, and display the image contents of the video data in a display interface of an electronic device;

an image detection module configured to detect the image contents in the video data; and

an image protection module configured to display an alternative image in the display interface of the electronic device to cover illegal contents when illegal contents satisfying a first illegal condition are detected in the image contents currently displayed.

According to the video playing method and the video playing device provided by the embodiments of the present disclosure, the image contents of the video data are detected while acquiring the video data to play, and when the illegal contents exist in the image contents currently displayed and are inappropriate for user to view, the alternative image may be displayed in the display interface of the electronic device to cover the illegal contents, so that users cannot view the illegal contents, which may effectively implement protection, does not need the users to operate, and improve the protection effectiveness and convenience of videos.

### BRIEF DESCRIPTION OF THE DRAWINGS

In order to explain the technical solutions in the embodiments of the disclosure or in the prior art more clearly, the drawings used in the descriptions of the embodiments or the prior art will be simply introduced hereinafter. It is apparent that the drawings described hereinafter are merely some embodiments of the disclosure, and those skilled in the art may also obtain other drawings according to these drawings without going through creative work.

FIG. 1 is a flow chart of one embodiment of a video playing method embodiment according to the present disclosure;

FIG. 2a to FIG. 2c are display schematic diagrams of an electronic device display interface of the present disclosure in a practical application respectively;

FIG. 3 is a flow chart of another embodiment of a video playing method according to the present disclosure;

FIG. 4 is a structure diagram of one embodiment of a video playing device according to the present disclosure; and

FIG. 5 is a structure diagram of another embodiment of the video playing device embodiment according to the present disclosure.

### DETAILED DESCRIPTION

To make the objects, technical solutions and advantages of the embodiments of the present disclosure more clearly, the technical solutions of the present disclosure will be clearly and completely described hereinafter with reference to the embodiments and drawings of the present disclosure. Apparently, the embodiments described are merely partial embodiments of the present disclosure, rather than all embodiments. Other embodiments derived by those having ordinary skills in the art on the basis of the embodiments of the disclosure without going through creative efforts shall all fall within the protection scope of the present disclosure.

When playing television program videos through a TV and playing network videos through a mobile phone, a tablet or the like, illegal contents inappropriate for users and especially inappropriate for children to view may exist in the videos. Because the identification ability of the children is limited, and the children have to receive the contents passively, while parents cannot accompany with the children all the time, how to process the illegal contents in the videos to protect the physical and psychological health of the children and avoid the children from impregnation of the illegal contents becomes an important technical problem needing to be solved.

Therefore, the inventor proposes the technical solutions of the embodiments of the present disclosure through a series of creative thinking. In the embodiments of the present disclosure, the image contents of video data are detected while playing the video data, and if illegal contents exist in the image contents, then an alternative image may be displayed in a display interface to cover the illegal contents, so that users cannot view the illegal contents and can see the alternative image only, thus being capable of implementing effective protection, not needing the users to operate, and being convenient to operate.

The technical solutions of the present disclosure will be described in details hereinafter with reference to the drawings.

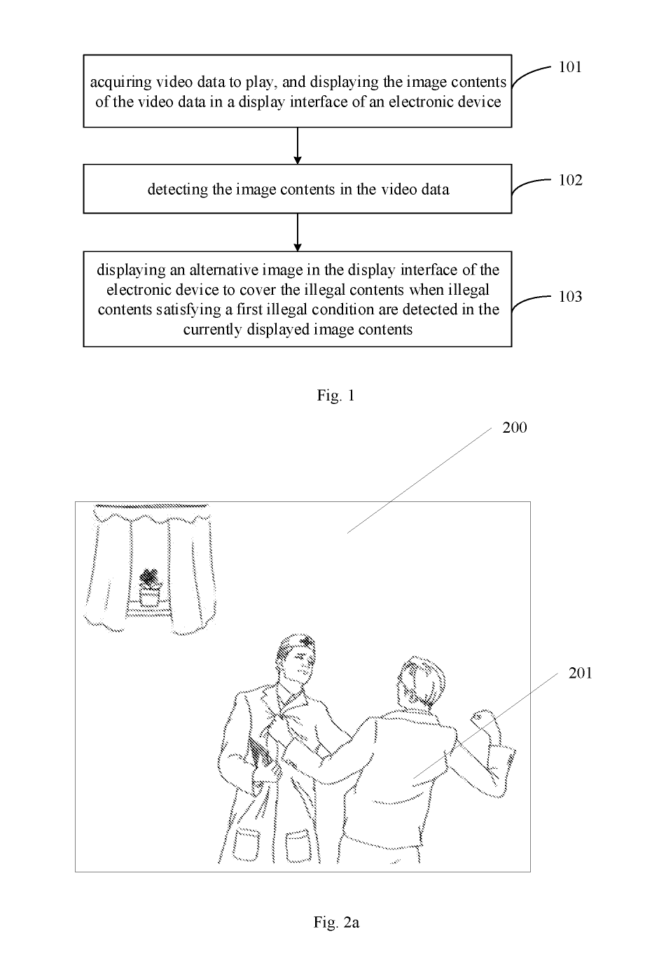

FIG. 1 is a flow chart of one embodiment of a video playing device provided by the embodiments of the present disclosure. The method is mainly applied to an electronic device, and may include the following several steps.

In step 101: video data is acquired to play, and the image contents of the video data in a display interface of the electronic device is displayed.

The electronic device may be a video playing device, such as a TV, a mobile phone, a tablet, a computer, or the like.

The video data may be a network video, a local video, a TV program, or the like.

The video data is composed of audio contents and image contents. When playing the video data, the image contents are displayed in the display interface of the electronic device.

In step 102: the image contents in the video data are detected.

Wherein, the image contents may be detected frame by frame, i.e., each frame of image in the video data is detected.

Moreover, because some contents in the image contents are inappropriate for a certain type of specific users to view during practical application. For example, some violent and pornographic contents in the image contents are inappropriate for children to view because the identification ability of the children is limited. Therefore, as another embodiment, the electronic device may also be set to at least have a children viewing mode. At this moment, detecting the image contents in the video data may specifically detecting the image contents in the video when the electronic device is under the children viewing mode. While under a non-children viewing mode, the image contents in the video data do not need to be detected. There may be various manners for determining whether the electronic device is under the children viewing mode, which will be introduced in the embodiments hereinafter.

In step 103: an alternative image is displayed in the display interface of the electronic device to cover the illegal contents when illegal contents satisfying a first illegal condition are detected in the image contents currently displayed.

The illegal contents satisfying the first illegal condition may refer to contents inappropriate for the users to view.

If the illegal contents exist in the image contents, the alternative image can be displayed to cover the illegal contents, so that the illegal contents cannot be viewed, and only the alternative image can be seen, which may protect the viewing user from the trespass of the illegal contents, does not need the user to operate, and improve the protection effectiveness and convenience of videos.

When no illegal contents are detected in the image contents, the displaying of the alternative image may be cancelled namely.

Wherein, the illegal contents satisfying the first illegal condition may refer to such contents that are inappropriate for the user to view as pornographic contents, violent contents, or the like.

Detection of the pornographic contents: detecting the illegal contents satisfying the first illegal condition in the image contents currently displayed may include: conducting skin color and grain detection on the image contents according to a skin color model, and using an image classifier to train and learn a sensitive organ image area, wherein the image classifier can be used to detect and acquire the illegal contents satisfying the first illegal condition.

Detection of the violent contents: detecting the illegal contents satisfying the first illegal condition in the image contents currently displayed may include: extracting moving objects in the image contents, analyzing the number and change rate of the moving objects in the image contents, acquiring the behavioral data of the moving objects, and determining that the illegal contents exist in the image contents if the behavioral data satisfies the first illegal condition.

Wherein, the alternative image may either be a blank image, or an image suitable for the user to view such as a cartoon image, a scene image, or the like.

Wherein, a probable implementation manner of displaying the alternative image in the display interface of the electronic device to cover the illegal contents is: displaying the alternative image matched with a size of the display interface in the display interface of the electronic device, so that the display interface displays the alternative image only, and the image contents of the video data played are covered, so that the user cannot view the image contents in the video data.

The alternative image may be popped up in the display interface of the electronic device in a pop-up box manner specifically when the image contents having illegal contents are detected, so as to cover the image contents having illegal contents.

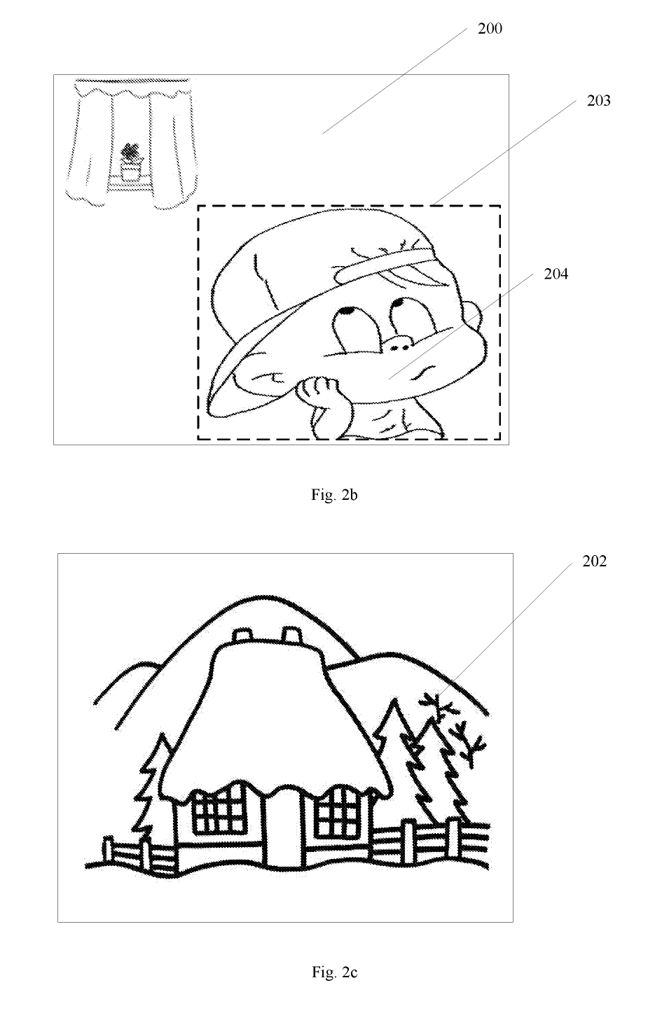

As shown in FIG. 2a-FIG. 2b, illegal contents 201 exist in the image contents currently displayed 200 of the display interface of the electronic device, then an alternative image 202 may be popped up in the display interface to cover the image contents currently displayed 200.

Another probable implementation manner is: the alternative image is displayed in a display area where the illegal contents locate in the display interface of the electronic device to cover the illegal contents. Therefore, the user cannot view the illegal contents in the image contents of the video data, and other contents in the image contents not including the illegal contents may also be displayed in the display interface.

Specifically, the display area of the illegal contents in the display interface is acquired, and the alternative image is popped up in the display area corresponding to the illegal contents in the display interface in a pop-up box manner to cover the illegal contents in the image contents.

As shown in FIG. 2c, an alternative image 204 may be displayed in a display area 203 (shown by the dashed box in the figure) where the illegal contents 201 of the display interface locate to cover the illegal contents 201 in the image contents 200.

In another embodiment, the electronic device at least has a children viewing mode, and there may be various manners for determining whether the electronic device is under the children viewing mode.

As a probable implementation manner, the electronic device may be switched to the children viewing mode when receiving a switching request of the user.

A control button may be set in the electronic device, and the user may switch the electronic device to the children viewing mode through triggering the control button. Certainly, the electronic device under the children viewing mode may also be switched to a normal viewing mode according to a request of the user.

For instance, when children are viewing videos, the electronic device may be switched to the children viewing mode by parents. Therefore, the image contents in the video data may be detected under the children viewing mode.

As another probable implementation manner, the physiological characteristic information of a viewing user may be collected.

When the physiological characteristic information satisfies a preset characteristic condition, the electronic device is switched to the children viewing mode.

Wherein, the physiological characteristic information may include high information, or the like.

The preset characteristic condition, for instance, may be that a collected height is lower than a preset height, or the like; and the viewing user may be deemed as younger, so that the electronic device may be switched to the children viewing mode, and the image contents in the video data may be detected under the children viewing mode.

Moreover, under the children viewing mode, if the physiological characteristic information of the collected viewing user does not satisfy the preset characteristic condition, then the electronic device may also be switched to the non-children viewing mode, i.e., the normal viewing mode.

The physiological characteristic information may be acquired through collecting images by an image collection module in the electronic device and analyzing the viewing users in the image acquired by collecting.

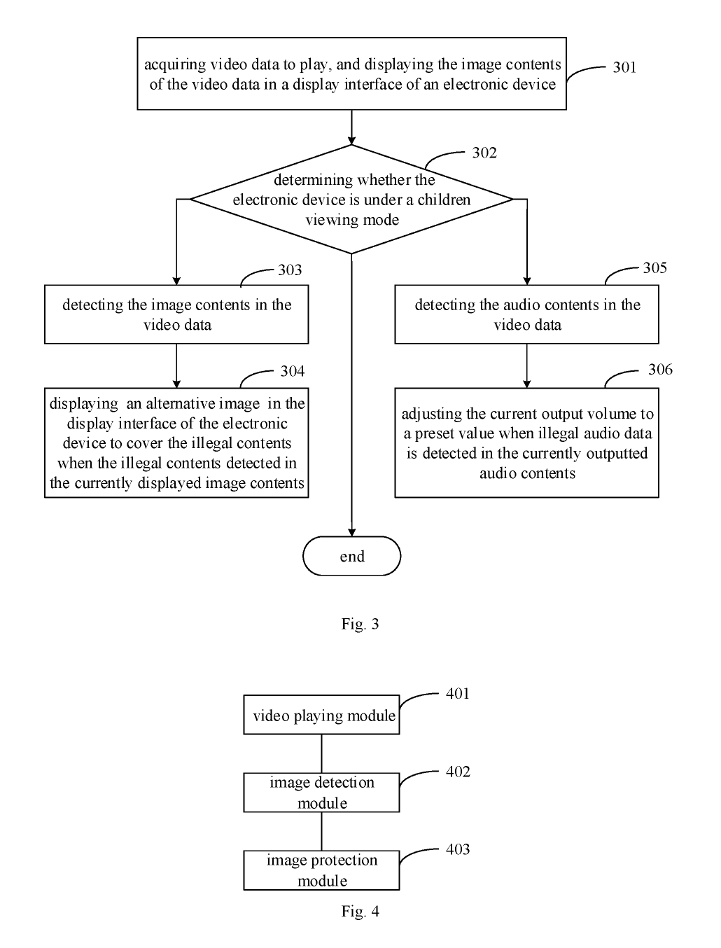

In addition, the audio contents may also be detected in the embodiment of the present disclosure excluding the image contents in the video data. Therefore, as another embodiment as shown in FIG. 3, the video playing method according to the embodiment of the present disclosure may include the following steps.

In step 301: video data is acquired to play, and the image contents of the video data is displayed in a display interface of the electronic device.

In step 302: the electronic device is determined whether to be under the children viewing mode; if yes, then step 303 and step 305 are performed; if not, then the flow is ended.

Determining whether the electronic device is under the children viewing mode may specifically determining whether a switching request of the user is received, or determining whether the physiological characteristic information satisfies the preset characteristic condition by collecting the physiological characteristic information of a viewing user; if yes, then it may be determined that the electronic device is under the children viewing mode.

In step 303: the image contents in the video data are detected.

In step 304: an alternative image is displayed in the display interface of the electronic device to cover the illegal contents when illegal contents satisfying a first illegal condition are detected in the image contents currently displayed.

When no illegal contents are detected in the image contents currently displayed, the displaying of the alternative image is cancelled, so that the viewing user may see the image contents currently displayed in the video data.

In step 305: the audio contents in the video data are detected.

In step 306: the current output volume is lowered to a preset value when illegal audio data satisfying a second illegal condition is detected in the currently outputted audio contents.

The illegal audio data satisfying the second illegal condition, for example, may be audio data including preset keywords, or the like, wherein the preset keywords may be characters, words or sentences inappropriate for the children to pick up. Therefore, the current output volume may be adjusted to a preset value, for example, the preset value may be 0, so that the user cannot clearly pick up the audio data.

When illegal audio data is not detected in the currently outputted audio contents, the volume of the electronic device current output is restored to an initial value, i.e., the volume before reduction.

Through the embodiment of the present disclosure, the alternative image may be displayed when the illegal contents exist in the image contents of the video data to cover the illegal contents; and the output volume may be adjusted to a lower value when the illegal audio data exists in the audio contents, so that the user cannot pick up the audio data; therefore, when the viewing user is a child, the child can be effectively protected from the trespass of the illegal contents and illegal audio data, and does not need parents to operate, so that the protection effectiveness and convenience of videos are improved.

FIG. 4 is a structure diagram of one embodiment of a video playing device provided by the embodiments of the present disclosure. The device is mainly applied to an electronic device, and the electronic device may include:

a video playing module 401 configured to acquire video data to play, and display the image contents of the video data in a display interface of the electronic device;

an image detection module 402 configured to detect the image contents in the video data; and

an image protection module 403 configured to display an alternative image in the display interface of the electronic device to cover illegal contents when illegal contents satisfying a first illegal condition are detected in the image contents currently displayed.

Wherein, the image detection module 402 is connected with the video playing module 401, and the image protection module 403 is connected with the image detection module 402.

As another embodiment, the electronic device has a children viewing mode. The image detection module 402 specifically detects the image contents in the video data when the electronic device is under the children viewing mode.

In the embodiment, if illegal contents exist in the image contents of the video data, the alternative image may be displayed to cover the illegal contents, so that the illegal contents cannot be viewed, and only the alternative image can be seen, which may protect the viewing user from the trespass of the illegal contents, does not need the user to operate, and improve the protection effectiveness and convenience of videos.

In addition, when no illegal contents are detected in the image contents by the image detection module, the image protection module may also cancel the displaying of the alternative image.

Wherein, the illegal contents satisfying the first illegal condition may refer to such contents that are inappropriate for the user to view as pornographic contents, violent contents, or the like.

The detection of the image detection module on the image contents currently displayed may include:

conducting skin color and grain detection on the image contents according to a skin color model, and using an image classifier to acquire the illegal contents satisfying the first illegal condition, wherein the image classifier is acquired through training and learning a sensitive organ image area; and,

extracting moving objects in the image contents, analyzing the number and change rate of the moving objects in the image contents, acquiring the behavioral data of the moving objects, and determining that the illegal contents exist in the image contents if the behavioral data satisfies the first illegal condition.

Wherein, the alternative image may either be a blank image, or an image suitable for the user to view such as a cartoon image, a scene image, or the like.

As a probable implementation manner, the image protection module may be specifically configured to:

display the alternative image matched with the size of the display interface in the display interface of the electronic device to cover the image contents currently displayed in the display interface when the illegal contents satisfying the first illegal condition are detected in the image contents currently displayed.

As another probable implementation manner, the image protection module may be specifically configured to:

display the alternative image in a display area where the illegal contents locate in the display interface of the electronic device to cover the illegal contents when the illegal contents satisfying the first illegal condition are detected in the image contents currently displayed.

In the embodiment of the present disclosure, there may be various manners for determining whether the electronic device is under a children viewing mode. Therefore, as another embodiment which is different from the embodiment as shown in FIG. 4, the device may also include:

an information collection module configured to collect the physiological characteristic information of a viewing user, the physiological characteristic information at least including the height information; and

a first mode switching module configured to when the physiological characteristic information satisfies a preset characteristic condition, switch the electronic device to the children viewing mode.

The image detection module specifically detects the image contents in the video data herein when the electronic device is under the children viewing mode.

As another embodiment which is different from the embodiment as shown in FIG. 4, the device may also include:

a second mode switching module configured to, when receiving a switching request of the user, switch the electronic device to the children viewing mode.

The image detection module specifically detects the image contents in the video data herein when the electronic device is under the children viewing mode.

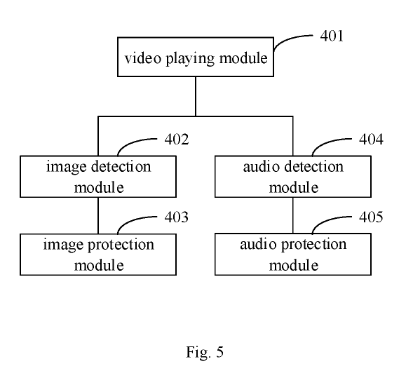

In addition, audio contents may also be detected in the embodiment of the present disclosure excluding the image contents in the video data. Therefore, as another embodiment which is as shown in FIG. 5 and different from the embodiment as shown in FIG. 4, the device may also include:

an audio detection module 404 configured to detect the audio contents in the video data; and

an audio protection module 405 configured to lower the volume of the electronic device current output to a preset value when illegal audio data satisfying a second illegal condition is detected in the currently outputted audio contents.

Wherein, the image detection module may specifically detect the audio contents in the video data herein when the electronic device is under the children viewing mode.

As another embodimen, A video playing device provided by the embodiments of the present disclosure, comprising:

one or more processors;

a memory; and

one or more modules stored in the memory, the one or more modules are configured to perform the following operations when being executed by the one or more processors:

acquiring video data to play, and displaying image contents of the video data in a display interface of an electronic device; detecting the image contents in the video data; and displaying an alternative image in the display interface of the electronic device to cover illegal contents, when the illegal contents satisfying a first illegal condition are detected in the image contents currently displayed.

Through the technical solutions of the embodiments of the present disclosure, the alternative image may be displayed when the illegal contents exist in the image contents of the video data to cover the illegal contents; and the output volume may be adjusted to a lower value when the illegal audio data exists in the audio contents, so that the user cannot pick up the audio data; therefore, when the viewing user is a child, the child can be effectively protected from the trespass of the illegal contents and illegal audio data, and does not need parents to operate, so that the protection effectiveness and convenience of videos are improved.

The device embodiments described above are only exemplary, wherein the units illustrated as separation parts may either be or not physically separated, and the parts displayed by units may either be or not physical units, i.e., the parts may either be located in the same plate, or be distributed on a plurality of network units. A part or all of the modules may be selected according to an actual requirement to achieve the objectives of the solutions in the embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer device (which may be a personal computer, a server, or a network device so on) to execute the method according to each embodiment or some parts of the embodiments.

It should be finally noted that the above embodiments are only configured to explain the technical solutions of the present disclosure, but are not intended to limit the present disclosure. Although the present disclosure has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the claims.

What is claimed is:

1. A video playing method, comprising:
at an electronic device with a display interface:
acquiring video data to play, and displaying image contents of the video data in the display interface of the electronic device;
detecting the image contents in the video data; and
displaying an alternative image in the display interface of the electronic device to cover illegal contents, when the illegal contents satisfying a first illegal condition are detected in the image contents currently displayed.

2. The method according to claim 1, wherein the detecting the image contents in the video data comprises:
detecting the image contents in the video data, when the electronic device is under a children viewing mode.

3. The method according to claim 2, wherein the electronic device is determined to be under the children viewing mode specifically according to a following manner:
acquiring physiological characteristic information of a viewing user; and
switching the electronic device to the children viewing mode, when the physiological characteristic information satisfies a preset characteristic condition.

4. The method according to claim 1, wherein the displaying the alternative image in the display interface of the electronic device to cover the illegal contents when the illegal contents satisfying the first illegal condition are detected in the image contents currently displayed comprises:
displaying the alternative image matched with a size of the display interface in the display interface of the electronic device to cover the image contents currently displayed in the display interface when the illegal contents satisfying the first illegal condition are detected in the image contents currently displayed.

5. The method according to claim 2, wherein displaying the alternative image in the display interface of the electronic device to cover the illegal contents when the illegal contents satisfying the first illegal condition are detected in the image contents currently displayed comprises:
displaying the alternative image matched with the size of the display interface in the display interface of the electronic device to cover the image contents currently displayed in the display interface when the illegal contents satisfying the first illegal condition are detected in the image contents currently displayed.

5. The method according to claim 1, wherein displaying the alternative image in the display interface of the electronic device to cover the illegal contents when the illegal contents satisfying the first illegal condition are detected in the image contents currently displayed comprises:
displaying the alternative image in a display area where the illegal contents locate in the display interface of the electronic device to cover the illegal contents, when the illegal contents satisfying the first illegal condition are detected in the image contents currently displayed.

6. The method according to claim 2, wherein displaying the alternative image in the display interface of the electronic device to cover the illegal contents when the illegal contents satisfying the first illegal condition are detected in the image contents currently displayed comprises:
displaying the alternative image in a display area where the illegal contents locate in the display interface of the electronic device to cover the illegal contents, when the illegal contents satisfying the first illegal condition are detected in the image contents currently displayed.

7. The method according to claim 1, wherein after acquiring the video data to play, and displaying the image contents of the video data in the display interface of the electronic device, the method further comprises:
detecting audio contents in the video data; and
lowering the volume of the electronic device current output to a preset value, when illegal audio data satisfying a second illegal condition is detected in the currently outputted audio contents.

8. The method according to claim 2, wherein after acquiring the video data to play, and displaying the image contents of the video data in the display interface of the electronic device, the method further comprises:
detecting audio contents in the video data; and
lowering the volume of the electronic device current output to a preset value, when illegal audio data satisfying a second illegal condition is detected in the currently outputted audio contents.

9. A video playing device, comprising:
a video playing module configured to acquire video data to play, and display the image contents of the video data in a display interface of an electronic device;
an image detection module configured to detect the image contents in the video data; and
an image protection module configured to display an alternative image in the display interface of the electronic device to cover the illegal contents when illegal contents satisfying a first illegal condition are detected in the image contents currently displayed.

10. The device according to claim 9, wherein the image detection module is specifically configured to detect the image contents in the video data when the electronic device is under a children viewing mode.

11. The device according to claim 10, wherein further comprising:
an information collection module configured to collect the physiological characteristic information of a viewing user; and
a first mode switching module configured to switch the electronic device to the children viewing mode, when the physiological characteristic information satisfies a preset characteristic condition.

12. The device according to claim 10, wherein the image protection module is specifically configured to:
display the alternative image matched with a size of the display interface in the display interface of the electronic device to cover the image contents currently displayed in the display interface when the illegal contents satisfying the first illegal condition are detected in the image contents currently displayed.

13. The device according to claim 11, wherein the image protection module is specifically configured to:
display the alternative image matched with a size of the display interface in the display interface of the electronic device to cover the image contents currently displayed in the display interface when the illegal contents satisfying the first illegal condition are detected in the image contents currently displayed.

14. The device according to claim 10, wherein the image protection module is specifically configured to:
display the alternative image in a display area where the illegal contents locate in the display interface of the electronic device to cover the illegal contents when the illegal contents satisfying the first illegal condition are detected in the image contents currently displayed.

15. The device according to claim 11, wherein the image protection module is specifically configured to:
display the alternative image in a display area where the illegal contents locate in the display interface of the electronic device to cover the illegal contents when the illegal contents satisfying the first illegal condition are detected in the image contents currently displayed.

16. The device according to claim 10, wherein further comprising:
an audio detection module configured to detect the audio contents in the video data; and
an audio protection module configured to lower the volume of the electronic device current output to a preset value when illegal audio data satisfying a second illegal condition is detected in the currently outputted audio contents.

17. The device according to claim 11, wherein further comprising:
an audio detection module configured to detect the audio contents in the video data; and
an audio protection module configured to lower the volume of the electronic device current output to a preset value when illegal audio data satisfying a second illegal condition is detected in the currently outputted audio contents.

18. A video playing device, comprising:
one or more processors;
a memory; and
one or more modules stored in the memory, the one or more modules are configured to perform the following operations when being executed by the one or more processors:
acquiring video data to play, and displaying image contents of the video data in a display interface of an electronic device;
detecting the image contents in the video data; and
displaying an alternative image in the display interface of the electronic device to cover illegal contents, when the illegal contents satisfying a first illegal condition are detected in the image contents currently displayed.
